(19) United States
(12) Patent Application Publication
(10) Pub. No.: US 2009/0078160 A1
(43) Pub. Date: Mar. 26, 2009

(54) Method and Composition for Producing an Item

(75) Inventor: Raffaella Di Girolamo, Roma (IT)

Correspondence Address: NIXON & VANDERHYE, PC, 901 NORTH GLEBE ROAD, 11TH FLOOR, ARLINGTON, VA, 22203, US

(73) Assignee: Keiper Holding S.R.L., Vicenza (IT)

(21) Appl. No.: 11/887,538

(22) PCT Filed: Mar. 28, 2006
(86) PCT No.: PCT/IB2006/000701

§ 371 Date: Nov. 29, 2007

(30) Foreign Application Priority Data
Apr. 1, 2005 (IT) MO2005A000075

(51) Int. Cl. A01G 9/02; C04B 28/26

(52) U.S. Cl. 106/606; 523/123; 106/600; 106/632; 106/634; 106/612

(57) ABSTRACT

A composition for producing an item for street furniture comprises: finely subdivided inert materials, an alkali metal polysilicate, a structuring agent, a surface-active agent; a method for producing an item for street furniture comprises: dispersing finely subdivided inert materials in a solution of an alkali metal polysilicate, so as to obtain a mixture; adding a surface-active agent and a structuring agent to said mixture; pouring said mixture into mould means and enabling said mixture to solidify, so as to produce said item.

The invention relates to a method and a composition for producing an item that can be made by forming in a mould, particularly a pot or a tub for street furniture. Pots and tubs intended for street furniture have to be aesthetically pleasing and have a substantially reduced weight. These items, when they are placed in historical parts of towns and/or in public parks, above all have to be architectonically harmonized with the surrounding buildings. Furthermore, since herbaceous plants or shrubs are placed together with the respective soils in the aforementioned items, the latter have to be made of a sufficiently light material. This is required in order to facilitate the personnel charged with transporting and placing the pots and the tubs in a definitive seat, so as to consequently reduce the risk of accidents during the performance of these operations.

For these reasons, in street furniture pots and tubs are normally used that are made of terra-cotta, i.e. by means of a clay-based composition to which water is added in order to form a mixture that is subsequently modelled, dried and baked.

According to the known methods, the mixture is placed in a suitable mould, which reproduces the shape and dimensions of the item to be made, for example a flowerpot, and which furthermore enables any decorative patterns to be created on a visible surface of the item. After a drying step, the items are extracted from the respective moulds and are baked in a kiln.

A drawback of the above disclosed method is due to the significant length of the item manufacturing cycle, which is due to the time required to complete the drying and baking steps.

Another drawback consists of the fact that the drying and baking steps have to be performed in proper apparatuses, i.e. dryers and kilns, which makes the manufacturing plant complicated and costly and causes significant energy consumption.

A further drawback is due to the significant weight of a terra-cotta pot of medium or large dimensions in which a plant, even of small or medium size, has been placed together with the respective soil. This pot is significantly inconvenient and hazardous to handle and transport when it has to be placed in a definitive seat, furthermore constituting a considerable static load to which any architectural elements are subjected on which the pot is placed.

Furthermore, a terra-cotta item used as an element of street furniture is significantly exposed to risks of breakage due to accidental blows or possible acts of vandalism.

An object of the invention is to improve the known methods and compositions for producing items, particularly pots and tubs for street furniture, which can be made by forming in a mould.

Another object is to provide a method and a composition for producing items for street furniture, such as pots and tubs for plants, that is significantly more rapid than the known methods.

A further object is to provide a method and a composition for producing items for street furniture, such as pots and tubs for plants, that enables the use of complicated apparatuses requiring significant energy consumption to be avoided.

Another further object is to provide an item for street furniture, in particular a pot or a tub for plants, having a specific weight that is lower than that of known items, so as to be substantially easy to handle and to be such as to produce a static load that is substantially not high for the architectural elements on which the item is placed.

Still another object is to provide an item for street furniture, in particular a pot or a tub for plants, which is substantially resistant to accidental blows.

In a first aspect of the invention, a composition is provided for producing an item for street furniture, comprising: finely subdivided inert materials, an alkali metal polysilicate, a structuring agent, a surface-active agent.

In a second aspect of the invention, a method is provided for producing an item for street furniture, comprising:
dispersing finely subdivided inert materials in a solution of an alkali metal polysilicate, so as to obtain a mixture;
adding a surface-active agent and a structuring agent to said mixture;
pouring said mixture into mould means and enabling said mixture to solidify, so as to produce said item.

Owing to these aspects, it is possible to make an item for street furniture, such as a pot or a tub for plants, provided with a lower specific weight compared with known items. This is made possible by the fact that the mixture solidifies in the mould means owing to a chemical reaction that occurs between the structuring agent and the polysilicate solution.

The item that is thus obtained can be handled in a substantially easy manner and it produces a substantially non-high static load for the architectural elements on which it is placed.

It is furthermore possible to add other components to the composition provided by the invention, such as for example fibres and/or polymers, so as to obtain an item provided with special mechanical resistance and/or impermeability properties.

Furthermore, the method provided by the invention does not require first drying the items and then baking the items in a kiln, which enables working time to be reduced and avoids the use of complicated and costly apparatuses consuming great quantities of energy.

A table is set out below showing the average percentage formula of a (anhydrous) composition according to the invention:

| Component | % range in weight |
|---|---|
| Ground inert materials | 10-90 |
| Alkali metal polysilicate | 10-90 |
| Structuring agent | 0.01-30 |
| Surface-active agent | 0.01-5 |

The ground inert materials can be obtained by grinding fragments of clay items (broken bricks), or from clay from clay pits, which clay is first baked at a temperature between 600-900° C. in a rotary kiln, which is of the known type and is not shown, and is subsequently ground. In both cases, grinding is conducted in such a way as to produce inert materials having granulometry comprised between 50 mμ and 1 mm. The inert materials may also comprise sand, ceramic sludge or other things.

In an embodiment, the ground inert materials are equal to approximately 60% of the composition.

The alkali metal polysilicate may comprise a sodium polysilicate (Na₂O.nSiO₂) and/or a potassium polysilicate (K₂O.nSiO₂)

In an embodiment, the (sodium or potassium) polysilicate is equal to approximately 40% of the composition. As a structuring agent propylene carbonate, ethylene carbonate, calcium oxide, white cement, hydraulic lime or insufflated carbon dioxide (CO₂) can be used. In an embodiment, the structuring agent comprises white cement and is equal to approximately 30% of the composition. The surface-active agent is, preferably, of the anionic type, or of the cationic or non-ionic type.

In an embodiment, the surface-active agent is equal to approximately 0.3% of the composition.

In a further embodiment it is possible to add pigments, for example oxides or anilines, to the aforementioned composition so as to obtain an item coloured in a desired manner.

In use, a water solution of an alkali metal polysilicate, for example sodium polysilicate, is used, which acts as a binder for the mixture, and the ground inert materials are then dispersed in this solution.

Once the dispersion has been prepared, the surface-active agent is introduced into the dispersion, for example in the form of a foam produced by a prior-art apparatus. The surface-active agent lowers the surface tension of the dispersion and consequently increases porosity in the item produced from the mixture.

Lastly, the structuring agent (for example propylene carbonate) is added to the dispersion, which structuring agent at ambient temperature reacts with the sodium polysilicate according to the following reaction:

C₄H₆O₃+H₂O+[SiₙO₂ₙ+1]⁻⁻ [symbol] C₃H₈O₂+CO₃⁻⁻+nSiO₂

Through the above mentioned reaction, a compact structure is given to the mixture. If white cement, or hydraulic lime, is used as a structuring agent, the white cement or the hydraulic lime reacts with the sodium silicate to give rise to calcium silicates.

In an embodiment, adding fibres to the dispersion before the structuring agent is provided for, which fibres are capable of increasing the mechanical resistance of the item made from the mixture. The fibres may be of vegetable origin, for example coconut or jute fibres, or be of organic origin (carbon, polypropylene) or be of inorganic origin (fibreglass).

In another embodiment, adding up to 15′ of polymers, for example resins, to the dispersion before the structuring agent is provided for, which polymers are able to increase the mechanical resistance or the impermeability of the item deriving from the mixture.

In a further embodiment, adding both the fibres and polymers, before the structuring agent, is provided for.

The mixture, once it has been prepared according to the procedure disclosed above, is poured into a mould of known type, which reproduces the shape and dimensions of an item for street furniture, for example a pot for plants.

In a time that is approximately comprised between 1 and 15 minutes, owing to the aforementioned reaction between sodium polysilicate and the structuring agent, the mixture acquires a solid structure, thus forming the item, i.e. the pot. Once the product has solidified, it is extracted from the mould and is ready to be stored or used.

From what has been disclosed above it is evident that the method provided by the invention is substantially rapid, simple and economical compared with known methods. Compared with the latter, in fact, this method neither requires complicated and costly systems nor the significant waste of time due to the steps of drying and baking of the items. Furthermore, by means of the composition and the method provided by the invention, it is also possible to produce building products, for example panels, in a substantially rapid and economical manner.

1-50. (canceled)

51. Composition for producing an item for street furniture, comprising: finely subdivided inert materials, an alkali metal polysilicate, a structuring agent, and a surface-active agent.

52. Composition according to claim 51, having a percentage formula comprising:

| | |
|---|---|
| finely subdivided inert materials | 10-90% |
| alkali metal polysilicate | 10-90% |
| structuring agent | 0.01-30% |
| a surface-active agent | 0.01-5% |

53. Composition according to claim 51, wherein said inert materials have a percentage value of 60.

54. Composition according to claim 52, wherein said alkali metal polysilicate has a percentage value of 40.

55. Composition according to claim 52, wherein said structuring agent has a percentage value of 30.

56. Composition according to claim 52, wherein said surface-active agent has a percentage value of 0.3.

57. Composition according claim 51, wherein said inert materials are selected from a group comprising: ground fired clay, sand, and ceramic sludge.

58. Composition according to claim 51, wherein said ground fired clay has granulometry comprised between 50 mμ and 1 mm.

59. Composition according to claim 51, wherein said alkali metal polysilicate comprises sodium polysilicate.

60. Composition according to claim 51, wherein said alkali metal polysilicate comprises potassium polysilicate.

61. Composition according to claim 51, wherein said structuring agent is selected from a group comprising: propylene carbonate, ethylene carbonate, calcium oxide, white cement, hydraulic lime, and carbon dioxide.

62. Composition according to claim 61, wherein said white cement has a percentage by weight that is equal to approximately 30%.

63. Composition according to claim 61, wherein said hydraulic lime has a percentage by weight that is equal to approximately 30%.

64. Composition according to claim 51, wherein said surface-active agent is selected from a group comprising: anionic surface-active agents, cationic surface-active agents, and non-ionic surface-active agents.

65. Composition according to claim 51, furthermore comprising fibres of vegetable origin, said fibres being selected from a group comprising: coconut fibres, and jute fibres.

66. Composition according to claim 51, furthermore comprising organic fibres, said organic fibres being selected from a group comprising: carbon and polypropylene.

67. Composition according to claim 51, furthermore comprising inorganic fibres.

68. Composition according to claim 67, wherein said inorganic fibres comprise fibreglass.

69. Composition according to claim 51, furthermore comprising polymers capable of making said item significantly resistant to mechanical stresses and/or humidity.

70. Composition according to claim 69, wherein said polymers have a percentage by weight that is equal to approximately 15%.

71. Composition according to claim 69, wherein said polymers comprise resins.

72. Composition according to claim 51, furthermore comprising pigments, said pigments being selected from a group comprising: oxides and anilines.

73. Method for producing an item for street furniture, comprising:
dispersing finely subdivided inert materials in a solution of an alkali metal polysilicate, so as to obtain a mixture;
adding a surface-active agent and a structuring agent to said mixture; and
pouring said mixture into a mould and enabling said mixture to solidify, so as to produce said item.

74. Method according to claim 73, furthermore comprising selecting said inert materials from a group comprising: ground fired clay, sand, and ceramic sludge.

75. Method according to claim 73, wherein said ground fired clay has granulometry comprised between 50 mμ and 1 mm.

76. Method according to claim 73, wherein said dispersing said inert materials occurs in an solution of sodium polysilicate.

77. Method according to claim 73, wherein said dispersing said inert materials occurs in an solution of potassium polysilicate.

78. Method according to claim 73, wherein said adding said surface-active agent comprises selecting said surface-active agent from a group comprising: anionic surface-active agents, cationic surface-active agents, and non-ionic surface-active agents.

79. Method according to claim 73, wherein said adding said structuring agent comprises selecting said structuring agent from a group comprising: propylene carbonate, ethylene carbonate, calcium oxide, white cement, hydraulic lime, and carbon dioxide.

80. Method according to claim 73, wherein said white cement has a percentage by weight that is equal to approximately 30%.

81. Method according to claim 73, wherein said hydraulic lime has a percentage by weight that is equal to approximately 30%.

82. Method according to claim 73, wherein said adding said structuring agent comprises insufflating said carbon dioxide in said mixture.

83. Method according to claim 73, wherein said finely subdivided inert materials have a percentage by weight that is comprised between 10% and 90%.

84. Method according to claim 83, wherein said finely subdivided inert materials have a percentage by weight that is equal to approximately 60%.

85. Method according to claim 73, wherein said alkali metal polysilicate has a percentage by weight that is comprised between 10% and 90%.

86. Method according to claim 85, wherein said alkali metal polysilicate has a percentage by weight that is equal to approximately 40%.

87. Method according to claim 73, wherein said structuring agent has a percentage by weight that is comprised between 0.01% and 30%.

88. Method according to claim 73, wherein said surface-active agent has a percentage by weight that is comprised between 0.01% and 5%.

89. Method according to claim 88, wherein said surface-active agent has a percentage by weight that is equal to approximately 0.3%.

90. Method according to claim 73, furthermore comprising adding fibres of vegetable origin to said mixture, said fibres of vegetable origin being selected from a group comprising: coconut fibres and jute fibres.

91. Method according to claim 90, wherein said adding said fibres of vegetable origin occurs before said adding said structuring agent.

92. Method according to claim 73, furthermore comprising adding organic fibres to said mixture, said organic fibres being selected from a group comprising: carbon and propylene.

93. Method according to claim 92, wherein said adding said organic fibres occurs before said adding said structuring agent.

94. Method according to claim 73, furthermore comprising adding inorganic fibres to said mixture, said inorganic fibres comprising fibreglass.

95. Method according to claim 94, wherein said adding said inorganic fibres occurs before said adding said structuring agent.

96. Method according to claim 73, furthermore comprising adding polymers to said mixture, said polymers comprising resins and being such as to make said item significantly resistant to mechanical stresses and/or humidity.

97. Method according to claim 96, wherein said adding said polymers occurs before said adding said structuring agent.

98. Method according to claim 96, wherein said polymers have a percentage by weight that is equal to approximately 15%.

99. Method according to claim 73, furthermore comprising adding pigments to said mixture, said pigments being selected in a group comprising: oxides and anilines.

100. Method according to claim 73, wherein said item is selected in a group comprising: pots, tubs for plants.
